(19) United States
(12) Patent Application Publication
(10) Pub. No.: US 2020/0269365 A1
(43) Pub. Date: Aug. 27, 2020

(54) METHOD FOR MACHINING OR INSPECTING A BLADE

(71) Applicant: MTU Aero Engines AG, MUNICH (DE)

(72) Inventor: Stefan Schwarz, Gilching (DE)

(21) Appl. No.: 16/801,169

(22) Filed: Feb. 26, 2020

(30) Foreign Application Priority Data
Feb. 27, 2019 (DE) 10 2019 202 673.7

(51) Int. Cl. B23P 15/02; F02C 3/00

(52) U.S. Cl. CPC B23P 15/02; F02C 3/00; F05D 2220/323; F05D 2230/20; F05D 2240/24

(57) ABSTRACT

A method machines or tests a blade for a turbomachine. The method includes: clamping the blade in a clamp such that a point contact or a line contact forms between the blade and the clamp as clamping partners. One of the clamping partners has a lower strength than the other clamping partner and plasticizes in the region of the point contact or the line contact.

### METHOD FOR MACHINING OR INSPECTING A BLADE CROSS-REFERENCE TO PRIOR APPLICATIONS

Priority is claimed to German Patent Application No. DE 10 2019 202 673.7, filed on Feb. 27, 2019, the entire disclosure of which is hereby incorporated by reference herein.

### FIELD

The present invention relates to a method for machining or testing a blade for a turbomachine.

### BACKGROUND

A turbomachine is functionally organized into the compressor, combustion chamber, and turbine In the case of an aircraft engine, intake air is compressed in the compressor and combusted in the downstream combustion chamber with kerosene mixed in. The resulting hot gas, a mixture of combustion gas and air, flows through the downstream turbine and is expanded in the process. As a rule, each of the turbine and the compressor has a multi-stage structure, where a respective stage includes a nozzle ring and a rotor blade ring. Each blade ring is constructed from a plurality of circumferentially consecutive blades that, depending on the application, have the compressor gas or the heating gas flowing around them.

In production, such blades can be machined in various ways; for example, material can be removed by machining with a geometrically defined or undefined cutting edge. On the other hand, because the blades are subjected to high loads during operation, a thorough testing of the blades may also be of interest. A vibration load, by means of which, for example, durability tests can be carried out or simulations can be compared, can have be of particular significance here. In both machining and testing, holding the blade reliably in the machining or testing apparatus can be a challenge.

### SUMMARY

In an embodiment, the present invention provides a method that machines or tests a blade for a turbomachine. The method includes: clamping the blade in a clamp such that a point contact or a line contact forms between the blade and the clamp as clamping partners. One of the clamping partners has a lower strength than the other clamping partner and plasticizes in the region of the point contact or the line contact.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 is a turbofan engine in an axial section;

FIG. 2 is a blade with a blade body and blade root;

FIG. 3 is a holder not according to the invention of the blade of FIG. 2 in a clamping device with surface contacts; and

FIG. 4 is a holder according to an embodiment of the invention of the blade according to FIG. 2 in a clamping device with point or line contact.

### DETAILED DESCRIPTION

The present invention addresses the technical problem of specifying an advantageous method for machining or testing a blade.

An advantageous innovation according to the present invention includes holding the blade with a clamping device, which is designed in such a way that a point or line contact is formed between the blade and the clamping device. In this case, one of the two clamping partners, that is to say the blade or the clamping device, is provided at least locally with a lower strength than the other clamping partner, and plasticizes in the region of the point or line contact. The clamping device is locally very limited, thereby or therefore, however, pressed against the blade with a high contact pressure.

An alternative approach includes, for example, to clamp a large area of the blade or a blade root with a complementarily shaped clamping device, for example a Christmas-tree-shaped blade root between metal blocks with complementary grooves. This results in comparatively large contact zones and, depending on the tolerance position, inhomogeneous surface pressures as well, particularly including locally low surface pressures. As a result, harmful adhesive sliding transitions may occur, which may result in damage to the blade and/or the clamping device, for example.

This can be prevented by the point or surface contact according to the invention between the blade and clamping device. The contact zones, which are better defined in comparison, can also, for example, be depicted better in simulations, which can be of interest specifically in material testing. With regard to vibration analyses, a linear behavior can result (for instance with respect to natural frequency, amplitude and attenuation) as a result of the point or line contact, for example over a wide excitation region, which can simplify the test implementation and evaluation.

Preferred embodiments of include method or use aspects in the representation of the features; in any case, the disclosure is implicitly to be read with regard to all claim categories.

The term “point or line contact” is to be understood herein as a technical term (not as an infinitesimally small point or a thin line in the mathematical sense). In the technical sense, this is a Hertzian contact, that is to say the smallest possible point or line contact surface, which results when the clamping device and the blade are pressed against one another under Hertzian pressure. For illustration, a corresponding point diameter or a line width can be, for example, at least 1/100 mm or 1/10 mm, wherein a possible upper limit can be, for example, at most 1 mm.

The “line contact” can be subdivided into a plurality of non-contiguous line contact regions. These may, for example, be arranged on opposite sides of the blade in such a way that the blade is reliably held therebetween, see in detail below. The same applies to the “point contact”, which can correspondingly be subdivided into a plurality of separate point contact regions between which the blade is then enclosed by different sides. The clamping jaws of the clamping device can be produced conventionally For example, it can be cut out of a metal block in a spark-erosive manner. In general, the blade, in particular a turbine blade, can also be made, for example, of nickel-based alloys; the clamping device (the clamping jaws) can also be made of a nickel-based alloy, which can then, for example, have a lower strength (is malleable).

Generally, the blade includes a blade body and a base or foot piece. This can be a blade root with a tooth or a tooth structure (in particular a Christmas-tree geometry) for insertion into a disk, but equally a disk piece together with blade body can also be cut out of a disk (blisk) formed integrally with blade bodies and clamped for test purposes, see in detail below. In principle, the blade can also be a guide blade, that is to say it can serve as a base, for example an inner or outer cover band section. Especially with regard to testing and vibration loading, however, the application can particularly be directed at a rotor blade.

In a preferred embodiment, the clamping device is the clamping partner with the lower strength; that is, it plasticizes the clamping device in the region of the point or line contact. In general, the strength comparison of the clamping partners relates to the contact region, i.e. the material properties of the blade and clamping device are considered where they are pressed against one another. In the case of the clamping device, for example, the strength of the clamping jaws between which the blade is clamped is used as a basis. In the case of the blade, for example, the strength of the blade body or of the blade root is used as a basis.

In a preferred embodiment, a line contact is formed between the blade and the clamping device. Preferably, the blade is clamped in such a way that a homogeneous surface pressure is present over the entire line contact. The clamping partner with the lower strength, that is to say, for example, the clamping device (its clamping jaws), thus plasticizes along the entire line contact, thus homogenizing the surface pressure. In figurative terms, any irregularities of the contact pressure along the line, which could result, for example, from slight uneven spots or misfits, are “eaten up” by the plastic deformation; the elastic component, which is constant along the line, remains. As a result, even the smallest tolerances or misfits can be compensated for, and the blade is optimally clamped. During the machining or in particular testing of the blade, no further placement occurs, and the blade is reliably held.

In a preferred embodiment, the clamping device is pressed with a normal force against the blade in the region of the point or line contact. This is considered locally in each case in the contact region; therefore, in the individual line contact or point contact regions, the contact force is in each case perpendicular to the respective surface region. By avoiding tangential components, the risk of exceeding the adhesive boundary can be prevented.

In a preferred embodiment, the blade is held in the clamping device in a kinematically defined manner, ignoring any tangential forces as well. The latter means that even if there were tangential forces (which is not preferred), these are disregarded. If only the normal forces between the blade and clamping device are considered, the blade is “kinematically defined” if firstly it cannot move and secondly the holder is not overdefined either. The latter means that there are no more contact regions than necessary in order to keep the blade immobile.

A preferred embodiment relates to a blade with a blade body and a blade root having a tooth or tooth structure. Viewed axially, the tooth or teeth can protrude in the circumferential direction. Such a blade root can be inserted axially into a complementarily shaped blade root receptacle in the disk. The blade root with two teeth can, for example, have a dovetail shape, with a plurality of radially offset teeth being referred to as a Christmas-tree geometry. Generally, within the scope of this disclosure, the terms “axial,” “radial,” and “circumferential,” as well as the associated directions, refer to the axis of rotation about which the blades rotate during operation (and which typically coincides with the longitudinal axis of the turbomachine).

In a preferred embodiment, the blade is clamped to the blade root. In this case, a region of the point or line contact is preferably arranged on a flank of the tooth pointing radially inward, and another region on a flank of the tooth pointing radially outward. Depending on the flank, the contact force is preferably perpendicular to the respective region, see above.

The blade root preferably has, circumferentially opposite, an additional tooth, which can form a dovetail profile with the tooth or can be part of a Christmas-tree structure. In a preferred embodiment, the blade root is then also clamped on the additional tooth, specifically again both on a radially inward pointing and on a radially outward pointing flank. On each of the flanks, the contact force is preferably perpendicular to the respective contact region, see above.

As already mentioned, the blade can alternatively also be separated from a blisk (blade integrated disk). It is then preferably held on the separated disk piece. In this case, the clamping device can, on the one hand, have the lower strength (see above); however, on the other hand, the blade can also be the clamping partner with the lower strength. In the case of the separated disk piece, the formation of a point contact or of point contact regions can in particular also be preferred.

In principle, a compressor blade can also be machined or tested in a manner described in the present case; the method is preferably used in a turbine blade.

In a preferred embodiment, the blade held in the clamping device is tested, namely subjected to a vibration load. In this connection, an advantage of the point or line contact can result, for example, such that the damping of the structure is significantly lower (no adhesive sliding transitions). Consequently, with conventional vibration exciters, higher loads can be introduced (which opens up a test regime which has hitherto not been accessible) or the same vibration input can be achieved with less excitation power. An advantage can also result, for example, in that, on account of the avoidance of the adhesive sliding transitions, an unintentional heat input can be prevented. Such a phenomenon could otherwise lead to pronounced fretting in the contact zones, as a result of which the blade and/or the clamping device can be damaged.

The invention also relates to the use of a blade and/or a clamping device in a method disclosed herein, that is to say in particular for holding the blade over a point or line contact.

The invention will be explained in more detail below with reference to an exemplary embodiment, a distinction still not being made in detail between the different claim categories.

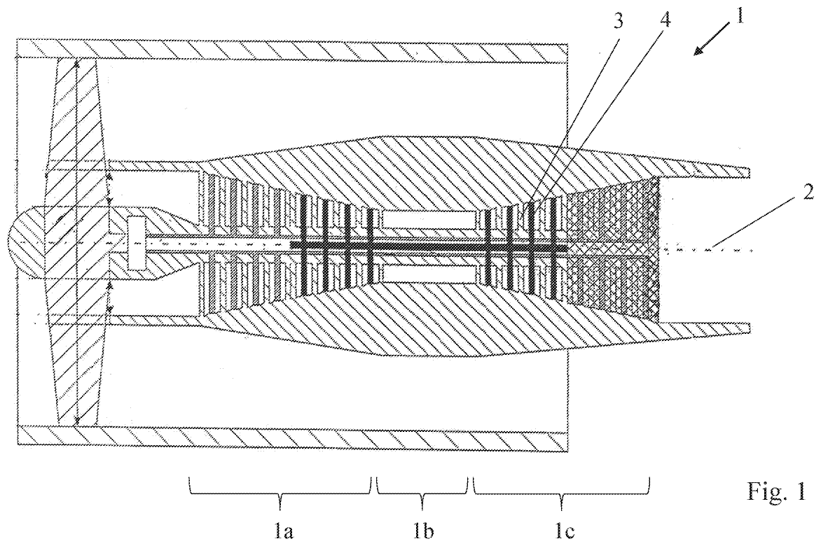

FIG. 1 shows a turbomachine 1, specifically a turbofan engine, in an axial section. The turbomachine 1 is organized functionally into compressor 1a, combustion chamber 1b, and turbine 1c. Both the compressor 1a and the turbine 1c are constructed of a plurality of stages. Each of the stages is composed of a guide and a rotor blade ring. For the sake of clarity, the rotor blade ring 3 and the associated rotor blade ring 4 are only referenced with reference signs for the turbine 1c for one of the stages. In the compressor 1a, the intake air is compressed, and is then combusted in the downstream combustion chamber 1b with kerosene mixed in. The heating gas flows through the hot gas channel and thereby drives the rotor blade rings which rotate about the axis of rotation 2.

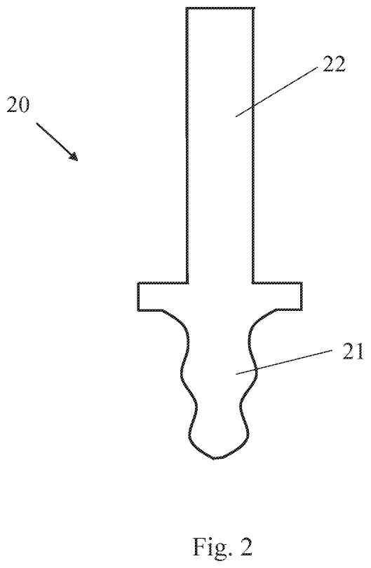

FIG. 2 shows a rotor blade 20, which is inserted as part of the rotor blade ring 4 into a rotor disk. A plurality of blade root receptacles is provided in a manner circumferentially distributed in the disk; in the finished mounted state, a blade 20 is inserted into each of them. For this purpose, the blade 20 has a blade root 21; FIG. 2 shows its profile in an axial view. The blade root 21 can be inserted axially into the respective blade root receptacles; the blade 20 together with the blade body 22 is then held in a positive-locking manner on the rotary disk.

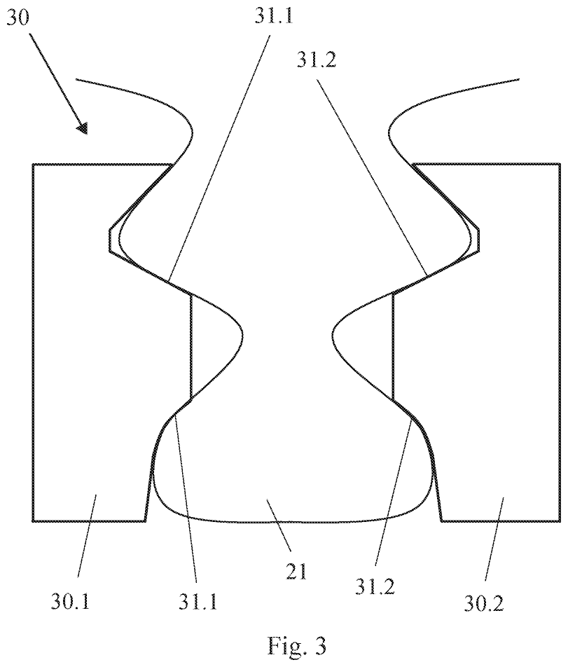

For checking or certification of the blades 20, they are subjected to different vibration loads. For such testing purposes, FIG. 3 illustrates a clamping device 30, which is not in accordance with the invention, with two clamping jaws 30.1, 30.2, each of which rests on the blade root 21 in a plurality of contact surfaces 31.1, 31.2. Due to the extensive contact, the contact pressure can be locally reduced, so that adhesive sliding transitions occur; compare the remarks in the introduction of the description in detail.

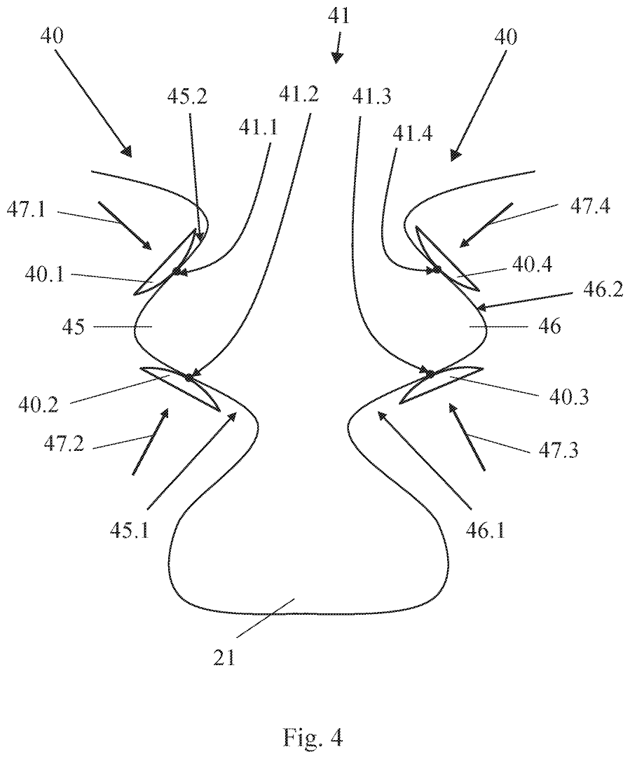

FIG. 4 shows a holder according to the invention of the blade joint 21 with a clamping device 40 via a point or line contact 41 having a plurality of regions 41.1-41.4. (in the present case, a line contact shown in a section perpendicular to the axial direction). In particular, the blade root 21 is supported on a tooth 45 and an additional tooth 46 which is circumferentially opposite, this being specifically on a radially inward pointing flank 45.1, 46.1 and a radially outward pointing flank 45.2, 46.2.

Each clamping device 40, specifically clamping jaws 40.1-40.4, has a convex contour; they are each pressed with a normal force 47.1-47.4. While, like the blade root 21, clamping jaws 40.1-40.4 are made of a nickel-based alloy, they have a lower strength. The normal force 47.1-47.4 is set so high that the clamping jaws 40.1-40.4 plasticize in each case in the region of the point or line contact 41. Reference is expressly made to the introduction of the description with regard to the advantages.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

Turbomachine 1

Compressor 1a

Combustion chamber 1b

Turbine 1c
Axis of rotation 2
Guide blade ring 3
Rotor blade ring 4
Rotor blade 20
Blade root 21
Blade body 22
Clamping device 30

Clamping jaw 30.1

Clamping jaw 30.2

Contact surface 31.1

Contact surface 31.2 p0 Clamping device 40

Clamping jaws 40.1-40.4
Point or line contact 41

Regions thereof 41.1-41.4
Tooth 45

Flanks thereof 45.1, 45.2
Additional tooth 46

Flanks thereof 46.1, 46.2
Normal forces 47.1-47.4

1. A method for machining or testing a blade for a turbomachine, the method comprising:
clamping the blade in a clamp such that a point contact or a line contact forms between the blade and the clamp as clamping partners,
wherein one of the clamping partners has a lower strength than the other clamping partner and plasticizes in the region of the point contact or the line contact.

2. The method according to claim 1, wherein the clamp is the one of the clamping partners that has the lower strength.

3. The method according to claim 1, wherein the clamp is provided in such a way that the line contact forms between the blade and the clamp.

4. The method according to claim 3, wherein the blade is clamped in the clamp in such a way that the one of the clamping partners that has the lower strength plasticizes such that a homogeneous surface pressure is present over the entire line contact.

5. The method according to claim 1, wherein the clamp is pressed against the blade in a region of the point contact or the line contact exclusively with a normal force.

6. The method according to claim 1, wherein the blade is clamped in the clamp in such a way that the blade is held in the clamp in a kinematically defined manner while ignoring any tangential forces.

7. The method according to claim 1,
wherein the blade has a blade body and a blade root, which is provided with a tooth for insertion into a complementary receptacle in a disk, and
wherein the blade is clamped in order to hold a blade joint.

8. The method according to claim 7, wherein the blade root is clamped in the clamp to such an extent that a region of the point contact or the line contact is formed both on a radially inward pointing flank of the tooth and a region of the point contact or the line contact is also formed on a radially outward pointing flank of the tooth.

9. The method according to claim 7,
wherein the blade root has an additional tooth circumferentially opposite the tooth, and
wherein the blade joint is clamped in the clamp to such an extent that a region of the point contact or the line contact is formed both on a radially inward pointing flank of the additional tooth and a region of the point contact or the line contact is also formed on a radially outward pointing flank of the additional tooth.

10. The method according to claim 1, wherein the blade is separated from a disk having a plurality of blade bodies integrally provided thereon prior to holding in the clamp, the blade being a disk piece with a blade body thereon during holding.

11. The method according to claim 10, wherein the disc piece is clamped in order to hold the blade.

12. The method according to claim 10, wherein the clamp is provided such that the point contact is formed between the blade and the clamp.

13. The method according to claim 1, wherein the blade is a turbine blade.

14. The method according to claim 1, wherein the blade held in the clamp is tested, testing comprising subjecting the blade to a vibration load via the clamp.

15. (canceled)
